(19) United States
(12) Patent Application Publication
(10) Pub. No.: US 2018/0283131 A1
(43) Pub. Date: Oct. 4, 2018

(54) FLOW LINE SEAL STRUCTURE FOR DIVERTER VALVE

(71) Applicant: SANDONG METAL INDUSTRY, gUMI-SI (KR)

(72) Inventor: SUK SOO CHANG, Daegu (KR)

(21) Appl. No.: 15/937,511

(22) Filed: Mar. 27, 2018

(30) Foreign Application Priority Data
Mar. 31, 2017 (KR) 10-2017-0041511

(51) Int. Cl. E21B 34/02; F16J 15/3284

(52) U.S. Cl. CPC E21B 34/02; F16J 15/3284

(57) ABSTRACT

Provided is a flow line seal structure for a diverter valve, in which a seal is formed between an inner housing and an outer housing of the diverter valve that prevents mud from flowing backward into a drill pipe provided outside a drill bit and rising, prevents the rising mud from being ejected into a drilling site, and diverts a direction of the mud so as to refine and reuse the mud in the process of forming an oil well by rotation of the drill bit during drilling, and breakage is prevented during assembly, assembly is facilitated, and sealing effect is improved. According to the present invention, it is easy to assemble the outer housing, and it is possible to prevent damage to the sealing member when the outer housing is assembled, thereby efficiently forming a seal, and accordingly, a diverter valve with improved sealing effect can be manufactured.

### CROSS REFERENCE TO RELATED APPLICATION

The present application claims priority to Korean Patent Application No. 10-2017-0041511, filed Mar. 31, 2017, the entire contents of which is incorporated herein for all purposes by this reference. This application relates to a project for “high pressure diverter for controlling oil well for offshore plant” which is performed by Sandong Metal Industry from Mar. 1, 2016 to Dec. 31, 2018 as a research project of “consumer-connected technology development business” supervised by the Korea Evaluation Institute of Industrial Technology within the Ministry of Trade, Industry and Energy.

### BACKGROUND OF THE INVENTION

### Field of the Invention

The present invention relates generally to a seal structure forming a seal of a diverter valve. More particularly, the present invention relates to a flow line seal structure for a diverter valve, in which a seal is formed between an inner housing and an outer housing of the diverter valve that prevents mud from flowing backward into a drill pipe provided outside a drill bit and rising, prevents the rising mud from being ejected into a drilling site, and diverts a direction of the mud so as to refine and reuse the mud in the process of forming an oil well by rotation of the drill bit during drilling, and breakage is prevented during assembly, assembly is facilitated, and sealing effect is improved.

### Description of the Related Art

Due to rapid international industrialization and industrial development, the use of earth resources such as petroleum is gradually increasing, and thus the stable production and supply of crude oil is becoming a very important issue on a global scale.

For this reason, the development of minor marginal oil fields or deep-sea oil fields, which have been neglected due to economic infeasibility, has become economically feasible in recent years. Therefore, along with the development of submarine mining technology, a drillship provided with drilling facilities suitable for the development of such oilfields has been developed.

A riser and a moon pool where the drill pipe moves up and down are provided in the center of the drillship, and a derrick is provided on the deck of the drillship, where various drilling rigs are concentrated.

Further, a drill bit is installed at the end of the drill pipe, and mud is used as the drilling fluid for the drilling operation of the drill bit. The mud is stored in a mud tank and circulated by a mud pump.

Meanwhile, the diverter valve used for drilling is installed on a drillship and a jack-up rig, and diverts the movement direction of the mud returning from the oil well, that is, the direction of movement of the rising mud to a refinement site when the oil well loses its control function, so as to refine and reuse the mud.

As shown in FIG. 1, the diverter valve roughly includes an inner housing 10′ provided with a flow line, an outer housing 20′ coupled to an outside of the inner housing 10′, and an upper housing 30′ coupled to an upper portion of the outer housing 20′, wherein the mud moving along the flow line provided in the inner housing 10′ is discharged through a discharge hole (not shown) formed through the outer housing 20′ and moved to a refinement site.

Here, the diverter valve includes a seal installed coupled to the outer circumferential surface of the inner housing 10′ at upper and lower portions of the inner housing to prevent the mud moving along the flow line from leaking between the inner housing 10′ and the outer housing 20′, whereby the mud moving to the flow line and the discharge hole is smoothly moved, and the maintenance demand of the valve due to leakage of the mud may be reduced.

Furthermore, to form a seal between the outer circumferential surface of the inner housing 10′ and the inner circumferential surface of the outer housing 20′, when the seal is installed in the outer circumferential surface of the inner housing 10′, the seal has a diameter larger than that of the inner housing 10′, and thus, when the outer housing 20′ is assembled to the inner housing 10′, the seal may be damaged or be separated from the correct position, and accordingly, the assembly is difficult and the maintenance demand is increased.

The foregoing is intended merely to aid in the understanding of the background of the present invention, and is not intended to mean that the present invention falls within the purview of the related art that is already known to those skilled in the art.

### DOCUMENTS OF RELATED ART

(Patent Document 1) Korean Patent Application Publication No. 10-2015-0043783

### SUMMARY OF THE INVENTION

Accordingly, the present invention has been made keeping in mind the above problems occurring in the related art, that a seal installed in an outer circumferential surface of an inner housing of a conventional diverter valve may be damaged or be separated when an outer housing is assembled making it difficult to form a seal, and the present invention is intended to propose a flow line seal structure for a diverter valve, in which the seal structure is provided on the outer circumferential surface of the inner housing of the diverter valve, and has a diameter smaller than that of the inner housing after installation, it is easy to assemble the outer housing, and it is possible to prevent damage to the sealing member when the outer housing is assembled, thereby efficiently forming a seal, and accordingly, a diverter valve with improved sealing effect can be manufactured.

In order to achieve the above object, there is provided a flow line seal structure for a diverter valve, in which the diverter valve diverts mud returning from an oil well to prevent the mud from being ejected during drilling, and includes: an inner housing provided with at least one flow line in a lateral direction; and an outer housing coupled to an outside of the inner housing, and provided with a discharge hole corresponding to the flow line, wherein the flow line seal structure includes: a sealing groove provided on an outer circumferential surface of the inner housing at each of positions above and below the flow line; a sealing member fitted over the sealing groove; and a hydraulic line provided in the inner housing, and configured to be open to the sealing groove.

Further, the sealing member may have an inner diameter smaller than an outer diameter of the sealing groove; the sealing member may include a hydraulic groove provided on an inner surface thereof to correspond to an end of the hydraulic line that is open to the sealing groove; the hydraulic groove may be configured such that a width thereof is gradually narrow toward an outside of the sealing member; and the sealing member may further include a pressure groove provided on at least one of upper and lower surfaces thereof.

According to the present invention, since the flow line seal structure for a diverter valve is provided on the outer circumferential surface of the inner housing of the diverter valve, and has a diameter smaller than that of the inner housing after installation, it is easy to assemble the outer housing, and it is possible to prevent damage to the sealing member when the outer housing is assembled, thereby efficiently forming a seal, and accordingly, a diverter valve with improved sealing effect can be manufactured.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a side sectional view showing a conventional diverter valve;

FIG. 2 is a perspective view showing a diverter valve according to an exemplary embodiment of the present invention;

FIG. 3 is a perspective sectional view showing the diverter valve according to an exemplary embodiment of the present invention;

FIG. 4 is a side sectional view showing the diverter valve according to an exemplary embodiment of the present invention;

FIG. 5 is a perspective sectional view showing an inner housing according to an exemplary embodiment of the present invention;

FIG. 6 is a perspective view showing a sealing member according to an exemplary embodiment of the present invention;

FIG. 7 is a side sectional view showing the sealing member according to an exemplary embodiment of the present invention; and

FIG. 8 is a partial side sectional view of the diverter valve showing an operating state of the sealing member according to an exemplary embodiment of the present invention.

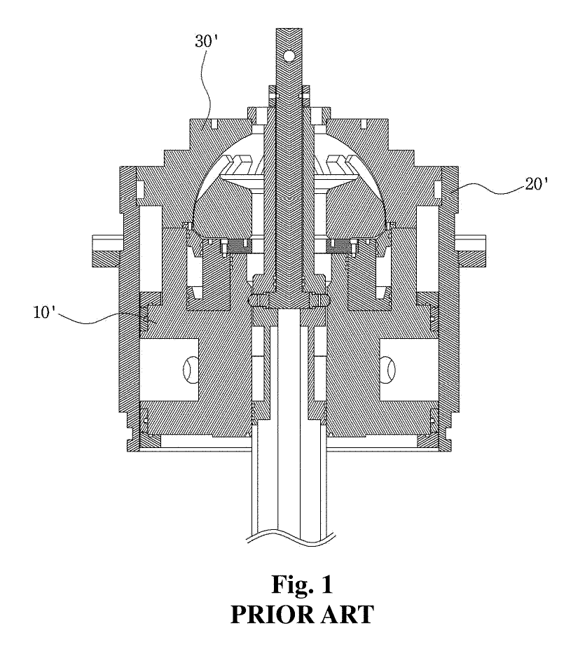

### DETAILED DESCRIPTION OF THE INVENTION

The present invention relates generally to a seal structure forming a seal of a diverter valve. More particularly, the present invention relates to a flow line seal structure for a diverter valve, in which a seal is formed between an inner housing 100 and an outer housing 200 of the diverter valve 10 that prevents mud from flowing backward into a drill pipe 20 provided outside a drill bit and rising, prevents the rising mud from being ejected into a drilling site, and diverts a direction of the mud so as to refine and reuse the mud in the process of forming an oil well by rotation of the drill bit during drilling, and damage to a sealing member 130 is prevented when the outer housing 200 is assembled to the outside of the inner housing 100, assembly is facilitated, and sealing is improved.

To achieve the above object, there is provided a flow line seal structure for a diverter valve, in which the diverter valve 10 diverts mud returning from an oil well to prevent the mud from being ejected during drilling, the flow line seal structure being configured such that the diverter valve 10 includes: an inner housing 100 provided with at least one flow line 110 in a lateral direction; and an outer housing 200 coupled to an outside of the inner housing 100, and provided with a discharge hole 210 corresponding to the flow line 110, wherein the inner housing 100 includes: a sealing groove 120 provided in an outer circumferential surface of the inner housing at upper and lower portions of the flow line 110; a sealing member 130 provided in the sealing groove 120; and a hydraulic line 140 provided in the inner housing, and configured to be connected to an inner surface of the sealing groove 120.

Further, the sealing member 130 of the present invention has a diameter smaller than a diameter of the sealing groove 120, and the sealing member 130 includes a hydraulic groove 132 provided in an inner surface thereof to correspond to an end of the hydraulic line 140 connected to the inner surface of the sealing groove 120. The hydraulic groove 132 is configured such that a width thereof is gradually narrow toward an outside of the sealing member 130, and meanwhile, the sealing member 130 further includes a pressure groove 134 provided on at least one of upper and lower surfaces thereof.

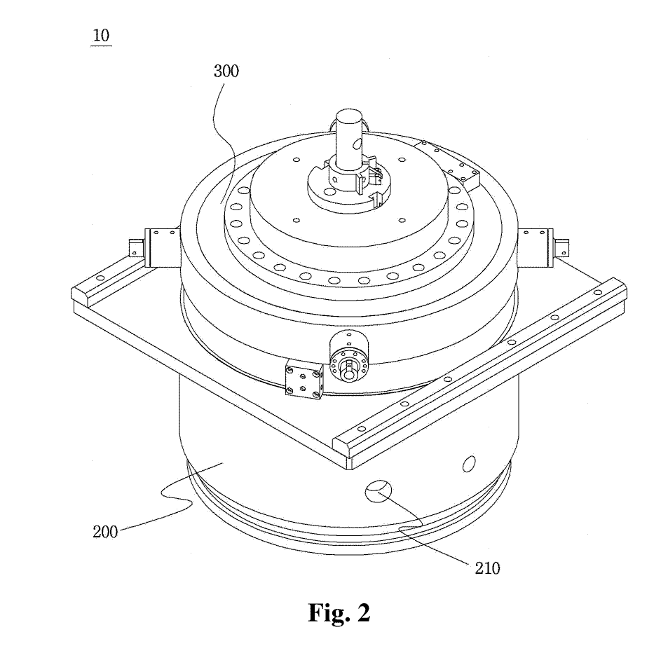

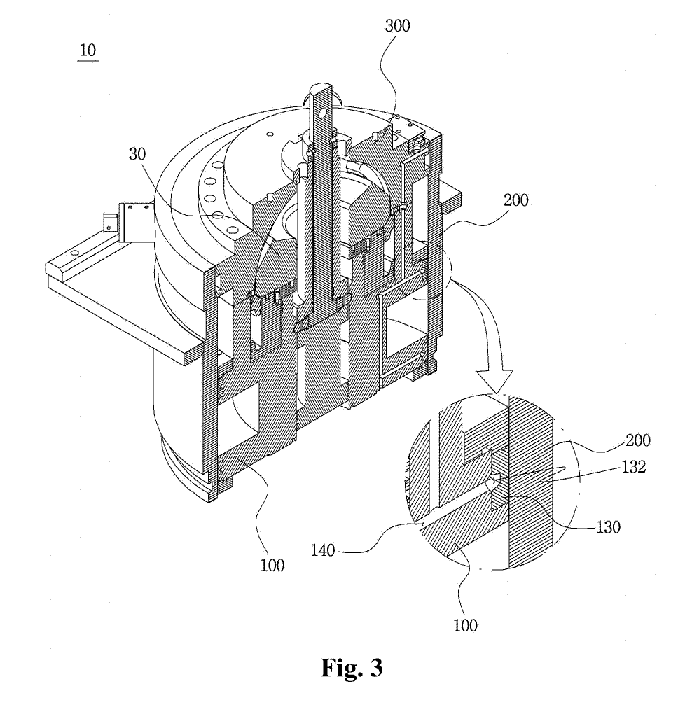

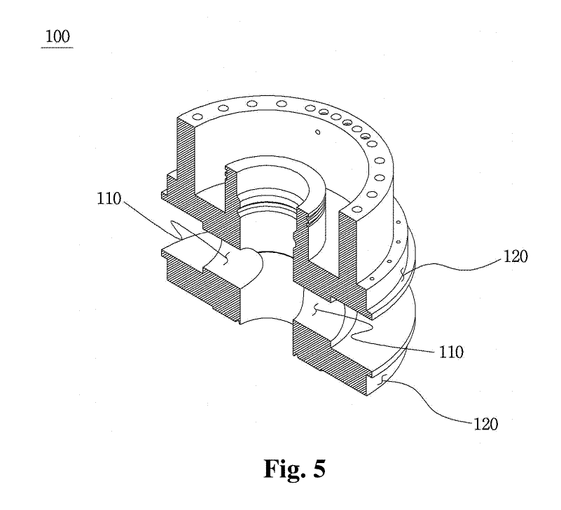

Hereinbelow, the present invention will be described in more detail with reference to FIGS. 2 to 8 showing an embodiment of the present invention.

Firstly, the diverter valve 10 used for drilling is installed on a drillship and a jack-up rig, and mud, which is used as a drilling fluid between a drill bit (not shown) and a drill pipe 20, is used for drilling to form an oil well. The diverter valve diverts the movement direction of the mud returning from the oil well, that is, the direction of movement of the rising mud to a refinement site (not shown) when the oil well loses its control function, so as to refine and reuse the mud.

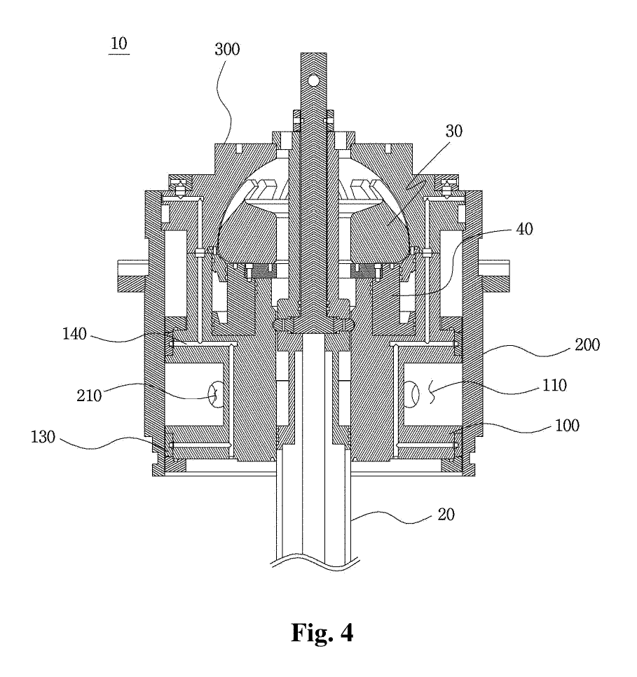

As shown in FIG. 4, the diverter valve 10 roughly includes the inner housing 100 provided with the flow line 110, the outer housing 200 coupled to the outside of the inner housing 100, and an upper housing 300 coupled to an upper portion of the outer housing 200, wherein the mud moving along the flow line 110 provided in the inner housing 100 is discharged through the discharge hole 210 formed through the outer housing 200 and moved to the refinement site.

Here, the diverter valve 10 of the present invention is configured such that the sealing member 130 is coupled to upper and lower portions of the outer circumferential surface of the inner housing 100 to prevent the mud moving along the flow line 110 from leaking between the inner housing 100 and the outer housing 200, whereby the mud moving to the flow line 110 and the discharge hole 210 is smoothly moved, and the maintenance demand of the valve 10 due to leakage of the mud may be reduced.

To be more specific, the diverter valve 10 of the present invention is configured as follows.

The diverter valve includes: the inner housing 100 provided with at least one flow line 110 in the lateral direction; and the outer housing 200 coupled to the outside of the inner housing 100, and provided with the discharge hole 210 corresponding to the flow line 110, wherein the inner housing 100 includes: the sealing groove 120 provided in the outer circumferential surface of the inner housing at upper and lower portions of the flow line 110; the sealing member 130 provided in the sealing groove 120; and the hydraulic line 140 provided in the inner housing 100, and configured to be connected to the inner surface of the sealing groove 120.

Here, the diverter valve 10 of the present invention is configured such that the upper housing 300 is coupled to the upper portion of the outer housing 200, a hemispherical sealing space (not shown) is formed in an upper portion of the upper housing 300, and a sealing element 30 is installed in the sealing space to seal the upper portion of the diverter valve 10, whereby the mud flowing backward from the drill pipe 20 is prevented from being ejected to the upper portion of the diverter valve 10.

In other words, the inner housing 100 is formed with a hollow hole (not shown) into which the drill pipe 20 is inserted and penetrates therethrough, and is provided with the flow line 110 communicating with the hollow hole, such that the mud flowing backward from the inside of the drill pipe 20 is moved along the flow line 110 not being moved upward by the upper housing 300.

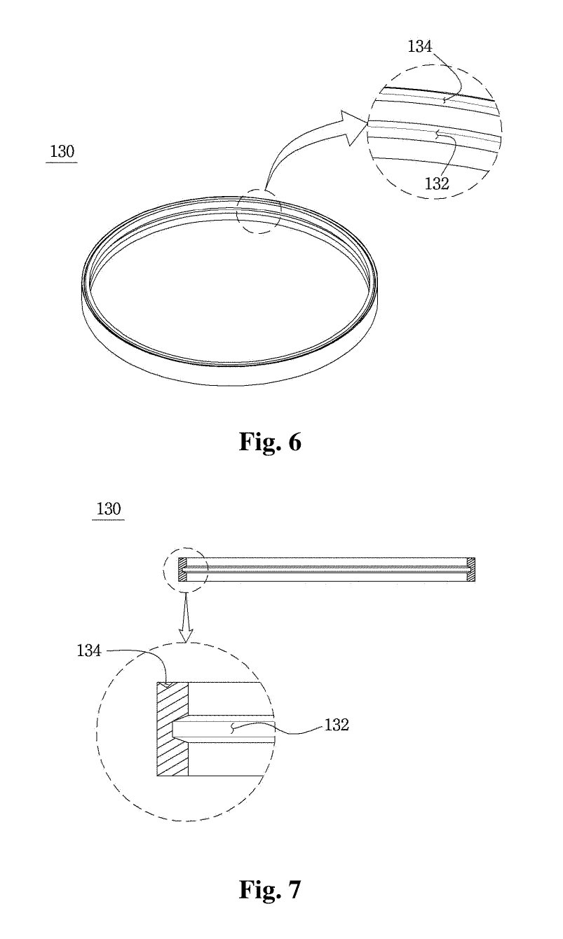

Further, the inner housing 100 includes the stepped sealing groove 120 provided in the outer circumferential surface of the inner housing at locations corresponding to the upper and lower portions of the flow line 110, and as shown in FIG. 6, the sealing member 130 is engaged with the sealing groove 120.

Further, as shown in FIG. 4, the inner housing 100 includes the hydraulic line 140 provided therein and connected to the inner surface of the sealing groove 120, and the sealing groove 120 is formed with a filling hole (not shown) communicating with the hydraulic line 140, whereby the sealing groove 120 is charged with hydraulic pressure through the hydraulic line 140.

Here, as shown in FIG. 4, the hydraulic line 140 is formed to the upper surface of the inner housing 100 and communicates with a hydraulic line (not shown) formed in the upper housing 300, and the hydraulic line formed in the upper housing 300 is formed to the upper surface of the upper housing 300, whereby hydraulic pressure is supplied from the outside.

Further, preferably, at least two hydraulic lines 140 are formed inside the inner housing 100 to efficiently extend the annular sealing member 130 outwardly by hydraulic pressure.

Furthermore, the sealing groove 120 is formed in the outer circumferential surface of the inner housing 100 at upper and lower portions of the flow line 110. In other words, the sealing groove is formed at upper and lower portions of the outer circumferential surface of the inner housing 100, at which the inner housing 100 and the outer housing 200 are brought into close contact with each other, and by sealing the uppermost and lowermost portions of the portion where the inner housing 100 and the outer housing 200 are brought into close contact with each other, a seal of the flow line 110 is formed.

In other words, since the sealing groove 120 is formed at the upper and lower ends of the outer circumferential surface of the inner housing 100 for the above reason, not only the outer surface but also the upper and lower portions thereof are open, whereby when the sealing member 130 is engaged with the sealing groove, a fastening ring (not shown) is coupled to each of the upper and lower portions of the sealing groove 120 formed at the upper and lower ends of the outer circumferential surface of the inner housing 100 to secure the sealing member 130.

In this regard, the sealing member 130, which is a main component of the present invention, is configured as follows.

The sealing member, which is installed in the sealing groove 120 of the inner housing 100, is formed in a ring shape and made of synthetic resin material having elasticity, thereby forming a seal between the inner housing 100 and the outer housing 200.

In other words, in a conventional diverter valve, when a seal is installed in the sealing groove of the inner housing, the seal has a diameter larger than that of the inner housing, whereby the outer housing is coupled to the outside of the inner housing by force fitting and then fastened using bolts, screws, etc.

Accordingly, when the outer housing is forcibly fitted over the outside of the inner housing, the seal may be damaged or be separated from the sealing groove, making assembly difficult, and when the seal is damaged, it is difficult to efficiently perform the drilling operation due to leakage of mud.

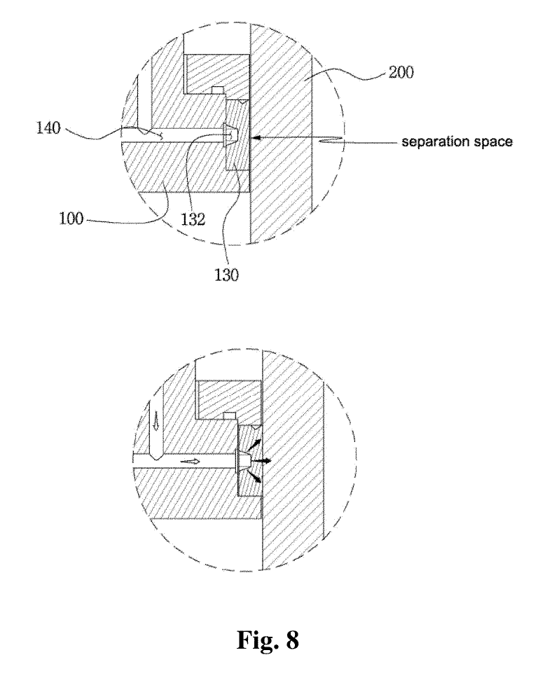

However, when the sealing member 130 of the present invention is installed in the sealing groove 120 of the inner housing 100, as shown in FIG. 8, the sealing member has a diameter smaller than that of the sealing groove 120, and since the sealing member 130 has a diameter smaller than that of the sealing groove 120, it is easy to assemble the outer housing 200 to the outside of the inner housing 100, and further, it is possible to solve the problem of the damage to the sealing member 130 and the separation from the sealing groove 120 when the outer housing 200 is assembled.

Furthermore, the sealing member 130 of the present invention includes the hydraulic groove 132 provided in the inner surface thereof to correspond to the end of the hydraulic line 140 connected to the inner surface of the sealing groove 120, wherein the hydraulic groove 132 communicates with the filling hole of the sealing groove 120 so as to charge the hydraulic pressure, and by the charged hydraulic pressure, the sealing member 130 expands outwardly, that is, in the direction of the outer housing 200, thereby forming a seal between the inner housing 100 and the outer housing 200.

In other words, the sealing member 130 of the present invention expands outwardly by the hydraulic groove 132, thereby forming a seal between the inner housing 100 and the outer housing 200, that is, a seal of the flow line 110.

Here, the hydraulic groove 132 is configured such that a width thereof is gradually narrow toward the outside of the sealing member 130. In other words, the width of the hydraulic groove 132 is gradually narrow toward the outside of the sealing member 130, and thus as shown in FIG. 8, the sealing member 130 charged with the hydraulic pressure expands not only in the outer direction but also in the upper outer direction and the lower outer direction, thereby improving the sealing.

Furthermore, as shown in FIG. 7, the sealing member 130 may further include the pressure groove 134 formed on one side of the upper and lower surfaces, wherein the pressure groove 134 pressurizes the sealing member 130 to expand toward the outer side and the inner side of the inner housing 100 by introducing mud or air flowing into the gap between the inner housing 100 and the outer housing 200.

In conclusion, the flow line seal structure for a diverter valve of the present invention is configured such that the sealing member 130 is installed in the outer circumferential surface of the inner housing 100, the outer housing 200 is installed in the outside of the inner housing 100, the upper housing 300 is installed in the outer housing, and hydraulic pressure is supplied such that the hydraulic pressure is charged in the hydraulic groove 132 of the sealing member 130 to form a seal between the inner housing 100 and the outer housing 200, whereby the seal of the flow line 110 is maintained.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A flow line seal structure for a diverter valve, in which the diverter valve (10) diverts mud returning from an oil well to prevent the mud from being ejected during drilling, and includes:
an inner housing (100) provided with at least one flow line (110) in a lateral direction; and
an outer housing (200) coupled to an outside of the inner housing (100), and provided with a discharge hole (210) corresponding to the flow line (110),
wherein the flow line seal structure comprises:
a sealing groove (120) provided on an outer circumferential surface of the inner housing at each of positions above and below the flow line (110);
a sealing member (130) fitted over the sealing groove (120); and
a hydraulic line (140) provided in the inner housing, and configured to be open to the sealing groove (120).

2. The flow line seal structure of claim 1, wherein the sealing member (130) has an inner diameter smaller than an outer diameter of the sealing groove (120).

3. The flow line seal structure of claim 1, wherein the sealing member (130) includes a hydraulic groove (132) provided on an inner surface thereof to correspond to an end of the hydraulic line (140) that is open to the sealing groove (120).

4. The flow line seal structure of claim 3, wherein the hydraulic groove (132) is configured such that a width thereof is gradually narrow toward an outside of the sealing member (130).

5. The flow line seal structure of claim 1, wherein the sealing member (130) further includes a pressure groove (134) provided on at least one of upper and lower surfaces thereof.
